(19) United States
(12) Patent Application Publication
(10) Pub. No.: US 2013/0130659 A1
(43) Pub. Date: May 23, 2013

(54) UPDATING SOCIAL NETWORKS IN RESPONSE TO TRIGGER EVENTS ON MOBILE COMMUNICATION DEVICE

(71) Applicants: Rita SADHVANI, Watchung, NJ (US); Hannah Youngsil MOON, Boston, MA (US)

(72) Inventors: Rita SADHVANI, Watchung, NJ (US); Hannah Youngsil MOON, Boston, MA (US)

(73) Assignee: Cellco Partnership d/b/a Verizon Wireless, Basking Ridge, NJ (US)

(21) Appl. No.: 13/302,431

(22) Filed: Nov. 22, 2011

(51) Int. Cl. H04W 4/00

(52) U.S. Cl. 455/414.1

(57) ABSTRACT

A wireless mobile communication device may include a wireless mobile communication module, an event detection module, and a social network update module. The wireless mobile communication module is configured to wirelessly communicate with at least one social network. The event detection module is configured to detect events that take place relating to the wireless mobile communication device. The social network update module is configured to cause the wireless mobile communication module to update the at least one social network with information that is descriptive of each event in response to the occurrence of the event.

Users of social networks, such as Facebook™, Twitter™, Myspace™, Linkedin™, and Google+™ often wish to update their web pages on these networks with information about events in which they have participated. However, they may forget to do so or find the process too inconvenient and/or time consuming.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of a wireless mobile communication device that updates social networks in response to trigger events that relate to the wireless mobile communication device.

FIG. 2 illustrates examples of interfaces that may be part of the event detection module illustrated in FIG. 1.

FIGS. 3A-3E illustrate an example of a process that may be implemented by the pre-event user option module illustrated in FIG. 1 to obtain multiple user options.

FIGS. 4A and 4B illustrate an example of a process that may be implemented by a phone call module within the wireless mobile communication device 101.

FIGS. 5A and 5B illustrate a process that may be implemented by the social network update module illustrated in FIG. 1.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

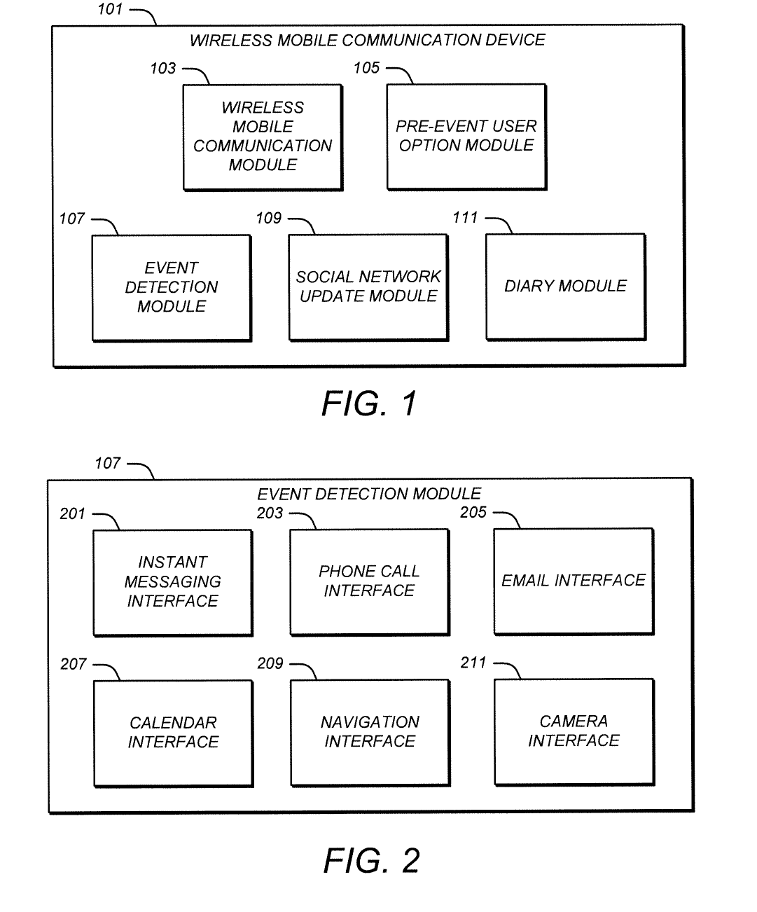

FIG. 1 illustrates an example of a wireless mobile communication device 101 that updates social networks in response to trigger events that relate to the wireless mobile communication device 101.

The wireless mobile communication device 101 may be of any type. For example, the wireless mobile communication device 101 may be a smartphone, laptop computer, tablet computer, or netbook.

The wireless mobile communication device 101 includes a wireless mobile communication module 103, a pre-event user option module 105, an event detection module 107, a social network update module 109, and a diary module 111. The wireless mobile communication device 101 may include additional modules or not all of these listed modules.

The wireless mobile communication module 103 is configured to wirelessly communicate with at least one social network, such as with Facebook™, Twitter™, MySpace™, LinkedIn™, and/or Google+™ A “social network,” as referred to herein, is a group of individuals who choose to be connected in order to stay in touch for various reasons including maintaining family ties and friendships, establishing new friendships and relationships, and even learning about new employment opportunities. This group of individuals may consist of family members, friends, classmates, girlfriends and boyfriends, and colleagues from work. The wireless mobile communication module 103 may be configured to effectuate such communication through any means, such as by communicating wirelessly with the social network(s) over the internet.

To obtain connectivity to the Internet, the wireless mobile communication module 103 may be configured to communicate through a WiFi connection to the internet, a cellular communication system that provides a gateway to the Internet, through an aircard, and/or through any other means. The wireless mobile communication module 103 may also be configured to communicate with other wireless mobile communication devices over a cellular network or through other means.

The event detection module 107 is configured to detect events that take place relating to the wireless mobile communication device 101. Such events may be of any type. For example, the events may consist of or include the arrival of an incoming communication to or the delivery of an outgoing communication from the wireless mobile communication device 101, such as an instant message, text message (which is different than an instant message), phone call, and/or email; the arrival of an event specified in an electronic calendar that is accessible to the wireless mobile communication device 101; the arrival of the wireless mobile communication device 101 at a specified geographic location; and/or the capture of an image or video stream by a camera associated with the wireless mobile communication device 101.

FIG. 2 illustrates examples of interfaces that may be part of the event detection module 107 illustrated in FIG. 1. As illustrated in FIG. 2, the event detection module 107 may include an instant messaging interface 201, a phone call interface 203, an email interface 205, a calendar interface 207, a navigation interface 209, and/or a camera interface 211.

Each interface may consist of or include computer software instructions that bring to the attention of the event detection module 107 the occurrence of a type of event that takes place related to the wireless mobile communication device 101. The instant messaging interface 201, for example, may be configured to bring to the attention of the event detection module 107 the arrival or delivery of each instant message. Similarly, the phone call interface 203 and the email interface 205 may be configured to bring to the attention of the event detection module 107 the arrival of or the delivery of a phone call or email, respectively. Correspondingly, the calendar interface 207 may be configured to bring to the attention of the event detection module 107 the arrival of an event in a calendar that is accessible to the wireless mobile communication device 101, such as an internal calendar or a calendar accessible over the Internet. The navigation interface 209 may be configured to bring to the attention of the event detection module 107 the arrival of the wireless mobile communication device 101 at a specified geographic location. Finally, the camera interface 211 may be configured to bring to the attention of the event detection module 107 the capture of an image or video by a camera that is associated with the wireless mobile communication device 101, such as a camera that is part of the wireless mobile communication device 101.

These interfaces may constitute computer code embedded in software applications that manage a type of event relating to the wireless mobile communication device 101, such as an instant messaging module for the instant messaging interface 201, a phone call module for the phone call interface module 203, an email module for the email interface 205, a calendar module for the calendar interface 207, a navigation module for the navigation interface 209, and a camera module for the camera interface 211. Other types of software applications that manage other types of events relating to the wireless mobile communication device 101 may also have embedded interfaces that similarly bring to the attention of the event detection module 107 the occurrence of such events.

The code that is embedded within each of these modules may be in the form of an application programming interface (API). When an event occurs of the type that is being managed by the module, one or more APIs within the module may be invoked.

Returning to FIG. 1, the pre-event user option module 105 is configured to allow a user of the wireless mobile communication device 101 to specify one or more options relating to some or all of the events that are detected by the event detection module 107. The wireless mobile communication device 101 may be configured to allow a user to specify and modify these options at any time, such as during or after the installation of a module that manages an event.

The pre-event user option module 105 may be configured to allow the user to specify these user options in any way. For example, the pre-event user option module 105 may be configured to allow the user to specify these options using a user interface that may be part of the wireless mobile communication device 101, such as a keyboard, pointing device, display, and/or touch screen.

One of the options that the pre-event user option module 105 may be configured to allow a user to specify is the type of events that are to trigger social network updates. The various types of triggering events that may be specified may include the arrival or delivery of a communication, such as an instant message, text message, phone call, and/or email; the commencement and/or conclusion of an event set forth in a calendar; the arrival of the wireless mobile communication device 101 at a specified geographic location; and/or the capture of an image or video by a camera that is associated with the wireless mobile communication device 101.

Another type of option that the pre-event user option module 105 may be configured to allow the user to specify is the persons or groups of persons with whom communications should trigger a social network update. Only communications with such selected persons or groups of persons would then trigger a social network update.

Another type of option that the pre-event user option module 105 may be configured to allow the user to specify is which of multiple social networks are to be updated in response to one or more of the triggering events.

Another type of option that the pre-event user option module 105 may be configured to allow the user to specify is which of multiple groups of people within the same social network are to be updated in response to any or all of such triggering events. These persons or groups of people in some examples may be the same as those triggering the update and in other examples may be different from those triggering the update.

The social network update module 109 is configured to cause the wireless mobile communication module 103 to update at least one social network with information that is descriptive of each triggering event. The social network update module 109 may be configured to do so by sending this descriptive information to a web page that is associated with each of the social networks and the user of the wireless mobile communication device 101.

The social network update module 109 may be configured to receive authentication information from a user in connection with each social network that is to be updated during a configuration process, such as a user name and password. This may allow the social network update module 109 to authenticate itself to each social network to which information that is descriptive of each triggering event is to be uploaded. The social network update module 109 may additionally be configured to receive from each user a URL or other type of address for each webpage or other area in each social network that is to be updated.

In connection with some or all of the triggering events, the social network update module 109 may be configured to cause the responsive update to be made automatically, i.e., without a user of the wireless mobile communication device 101 having to take any action following the occurrence of the triggering event to cause the update to be made. In these situations, information that is descriptive of the triggering event may automatically be provided by the module that was managing the triggering event through its associated interface to the event detection module 107.

For example, a communication module that receives a communication, such as an instant message, text message, phone call, or email, may be configured to forward information descriptive of the communication, such as the time of the communication and the name, phone number, and/or email address of the sender, through its interface to the event detection module 107. In turn, the event detection module 107 may be configured to provide this descriptive information to the social network update module 109. The social network update module may then automatically add language to this information explaining its significance, such as “John Jones [i.e., the pre-programmed user of the wireless mobile communication device 101] received [type of communication, e.g. an email message] from [insert name of sender] on [insert date/time]”

The social network update module 109 may be configured to communicate with a contact database that is either within the wireless mobile communication device 101 or accessible to it for the purpose of translating telephone numbers and email addresses into names, thereby allowing the name of the sender to be used in the update, in lieu of the telephone number or email address. Such translation may be set by the user of the wireless mobile communication device 101 to be either automatic or manual. Whether the translation is automatic or manual may be dependent on, for example, the type of communication, the type of information being translated, and the person or group being updated.

In connection with calendar events, the event detection module 107 may detect an event in a calendar based on the arrival of the calendared time for the event and provide the description of that event that appears in the calendar and that was received through the calendar interface 207 to the social network update module 109. The social network update module 109 may cause an appropriate message to be posted automatically to the designated social network(s), such as “[Insert name of user] has just begun [insert description of event as set forth in calendar].”

In connection with navigation events, a navigation module may detect that the wireless mobile communication device 101 has arrived at a programmed destination. Notice of this event, along with information identifying the destination, may be provided through the navigation interface 209 to the event detection module 107 and, in turn, to the social network update module 109. The social network update module 109 may be configured to use language such as “[Insert name of user] has just arrived at [insert name of programmed destination].” If the programmed destination is a street address or geographic coordinates, the social network update module 109 may be configured to communicate with a name-location database for the purpose of translating the address or coordinates into the name of the location, such the name of a theatre, airport, or school.

In connection with images that may be captured by a camera associated with the wireless mobile communication device 101, the event may be detected by the event detection module 107 through the camera interface 211 and reported to the social network update module 109. In turn, the social network update module 109 may be configured to communicate appropriate information to the at least one social network, such as “[Insert name of user] has just captured an image [or video] at [insert location].” The social network update module 109 may be configured to access the location information from a navigation module within the wireless mobile communication device 101, again translating coordinate information into a name using a coordinate-name database, if desired.

The pre-event user option module 105 may be configured to allow a user to specify the types of information and the particular language that is used by the social network update module 109 to convey event information. The language used may be selected from a set of predetermined computer generated communications or may be manually tailored by the user prior to the automatic posting dependent on the event. In connection with incoming communications, for example, the user may be permitted to specify whether the name, address, phone number, time, location of the recipient at the time of the communication, and/or other types of information are to be specified and, if so, with what language. In connection with calendared events, for example, the user may be allowed to specify whether the user's location, as determined by a navigation module, is to be provided, along with an alert about the commencement of the calendared event. In connection with the capture of images or video, for example, the user may be allowed to specify whether the user's location is to be included in the update and, if so, in what form (e.g., an address, geographic coordinates, and/or a location name). The language used in automatic posting may be dependent on, for example, the type of trigger event, location, or social network to which the update is to be posted. Thus, for example, different language may be used in different postings to different social networks and/or groups of people within each social network that are triggered by the same trigger event.

In response to the occurrence of some or all of the trigger events, the social network update module 109 may be configured to ask a user of the wireless mobile communication device 101 whether the user wishes to update one or more social networks with information descriptive of the event. The social network update module 109 may be configured to provide the update if and only if the user responds in the affirmative. The user may also be allowed to specify the update that is to be provided. The user may instead be presented with a proposed update, such as in one of the formats discussed above, and be given the option to modify it before it is sent.

The social network update module 109 may provide the user with the option to defer advising whether the user wishes to update the social network with information descriptive of the event. If the user answers in the affirmative, the social network update module 109 may ask the user the same question at a later time. The user interface may allow the user to specify the length of the deferment. The update will be provided only of the user ultimately authorizes it in answer to this question in this embodiment.

The social network update module 109 may be configured to ask the user whether the user wishes to defer updating the social network with information descriptive of the event. The social network update module 109 may be configured to defer the update if the user answers in the affirmative. The user interface presenting this question may also allow the user to specify the length of the deferment.

The diary module 111 may be configured to store information that is descriptive of all of the events in a single database. The database may be located within the wireless mobile communication device 101, in an external server, or elsewhere. This information may be received from the event detection module 107 and may be the same or comparable to the types of information that the social network update module 109 reports to the social networks, as discussed above. In this way, information about events of vastly different types may all automatically be gathered together and stored in a single database, such as information about communications, calendared events, navigation events, and image/video capture events. The pre-event user option module 105 may be configured to allow a user to specify the types of events about which descriptive information is stored in the diary module 111.

The diary module 111 may be configured to provide reports on request about the event information that is stored. The diary module 111 may be configured to allow a user to sort and/or filter the event information that is stored, such as by date, time, person, and/or type. The reports may be provided in any format, such as in a table format. The diary module 111 may be configured allow the stored information to be exported, such as to a text, CSV, or Excel™ file, or transmitted to a different system, such as to a text file.

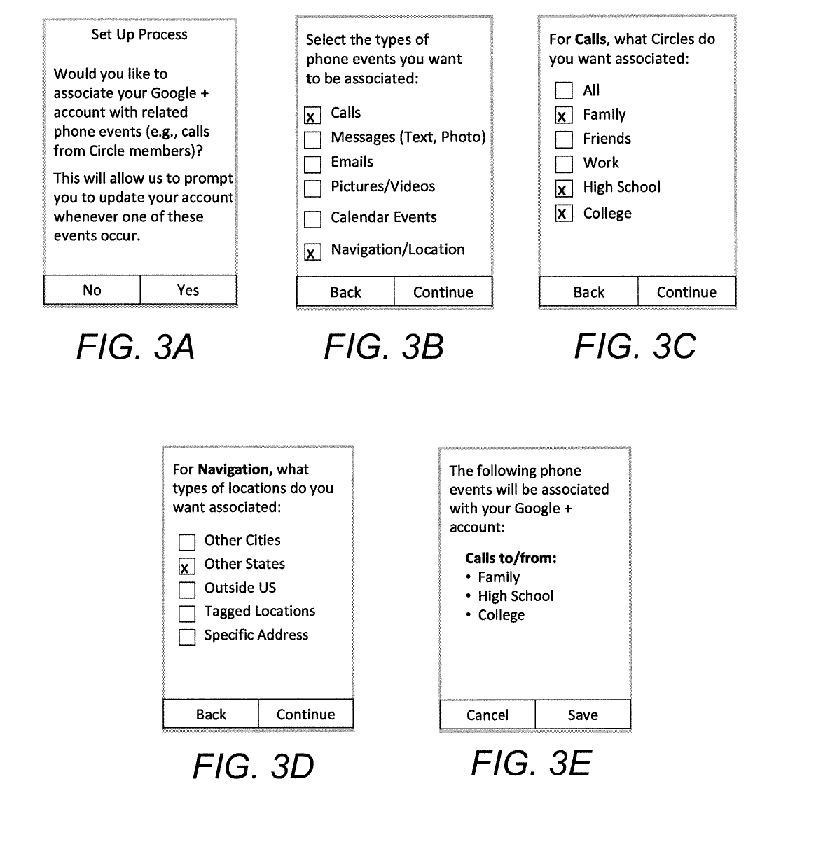

FIGS. 3A-3E illustrate an example of a process that may be implemented by the pre-event user option module 105 illustrated in FIG. 1 to obtain multiple user options. The dialog boxes that are illustrated in FIGS. 3A-3E may be presented to a user at the time the user installs an application for a social networking site, such as Google+. The dialog boxes may also be presented at a different time, such as when the application is first activated. The application for the social network may itself generate these dialog boxes and thus be part of the pre-event user option module 105. In a different configuration, the application may trigger a separate pre-event user option module to present these dialogs.

FIG. 3A illustrates a dialog box that may be presented asking the user whether she would like to provide event updates to her Google+ account. The user may answer “yes” or “no,” as preferred. If the user answers “no,” no further dialog boxes will appear and no updates will be provided to her Google+ account. If the user answers “yes,” on the other hand, the dialog box illustrated in FIG. 3B may appear.

This dialog box in FIG. 3B asks the user about the types of phone events that are to trigger an update to the user's Google+ account. An illustrative set is listed. The user may select those types that are of interest and then “Continue” to continue.

Each selected type of event may then be the subject of further questions to the user. For example, FIG. 3C illustrates a dialog box that appears in response to the user's selection of “Calls” in FIG. 3B. The dialog box in FIG. 3C allows the user to select the groups of persons with whom communications (as shown, phone calls) occur that are to trigger an update. Again, an example set is illustrated.

FIG. 3D illustrates a dialog box that may be presented after the selection of the “Navigation/Location” type of event in FIG. 3B. As illustrated in FIG. 3D, the user may select the types of locations that are to trigger updates upon arrival. The update may instead be configured to be triggered by the departure from a specific location and/or by the arrival at a location that is within a pre-determined distance of a specific location.

The options of “Other Cities” and “Other States” mean that an update event is only triggered upon arrival at (or departure from) a city or state outside of the user's home city or state. The user's home city and/or state may be provided through a dialog box during the setup of the wireless mobile communication device and/or obtained from an account associated with the wireless mobile communication device. If “Specific Address” is selected, a further dialog box may be presented that allows the user to specify one or more specific addresses. When finished, the user may select “Continue” to continue.

FIG. 3E provides confirmation of selections that have been made. Confirmation of other selections may also be provided. After reviewing them and verifying their accuracy, a user may select “Save” to save these pre-event options, following which the selected options are implemented.

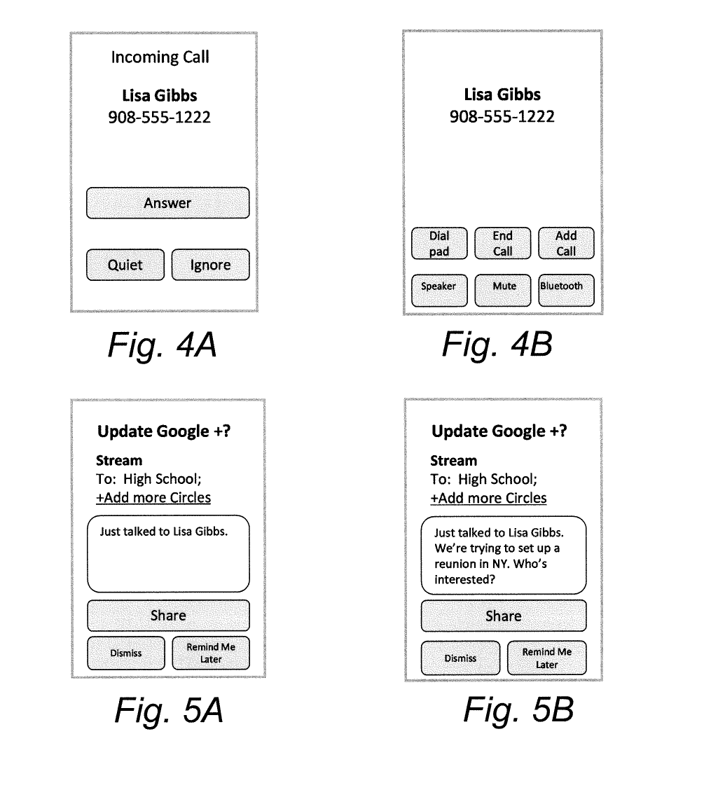

FIGS. 4A and 4B illustrate an example of a process that may be implemented by a phone call module within the wireless mobile communication device 101. FIG. 4A illustrates a dialog box that may be presented to alert the user to an incoming call. The user may select “Answer” to answer the call, “Quiet” to stop the ringing, or “Ignore” to allow the ringing to continue. FIG. 4B illustrates call handling options that may be provided to the user after the user selects “Answer” in FIG. 4A.

FIGS. 5A and 5B illustrate a process that may be implemented by the social network update module 109 illustrated in FIG. 1. FIG. 5A illustrates a dialog box that may be presented to the user after the user selects “End Call” in FIG. 4B. This dialog box may be presented immediately after the call or automatically delayed based on factors such as other activity that may be ongoing with the wireless mobile communication device and/or the user's location. The timing of the presentation of this dialog box may be user configurable.

As illustrated in FIG. 5A, the dialog box asks the user whether the user wishes to update her social network account at Google+ and, if so, with exactly what message. The message illustrated in FIG. 5A may be proposed by the social network update module 109 as a default for the user to accept or modify, as the user wishes. The dialog also specifies the group to which the update will be provided, allowing the user to add more groups, if desired. The user may then cause the update to be made by selecting “Share.” The user may instead decline to provide any update, by selecting “Dismiss;” or may request to be asked this question later by selecting “Remind Me Later.”

The delivery of updates may have both an automated and a manual component. The automated component may result in updates automatically being provided to the social network upon the occurrence of a triggering event, as discussed above. The manual component could result in a dialog box, such as the one illustrated in FIG. 5A, also being displayed, thereby giving the user an opportunity to supplement the automatic posting with additional comment.

Unless otherwise indicated, each of the modules that have been discussed may be implemented with a computer system configured to perform the functions that have been described herein for the module. The computer system includes one or more processors, memory devices (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

The computer system may include software (e.g., one or more operating systems, device drivers, application programs, and/or communication programs). When software is included, the software includes programming instructions and may include associated data and libraries. When included, the programming instructions are configured to implement one or more algorithms that implement one more of the functions of the computer system, as recited herein. Each function that is performed by an algorithm also constitutes a description of the algorithm. The software may be stored on one or more non-transitory, tangible storage devices, such as one or more hard disk drives, CDs, DVDs, and/or flash memories. The software may be in source code and/or object code format. Associated data may be stored in any type of volatile and/or non-volatile memory.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

For example, in one configuration the prompt that is provided to a user after a trigger event is detected may allow the user to select the social networks and groups or individuals in these networks to which the update is to be provided. Certain types of social networks, such as a network of employees of a company, may also be flagged by the user as sensitive. A warning box asking for user confirmation may then be displayed in response to trigger events for such social networks asking the user to confirm the update to protect against an embarrassing and inadvertent posting. In different examples, if multiple social networks including at least one sensitive group and at least one non-sensitive group are to be updated due to the same trigger event being detected, the update of all groups or only the sensitive groups may be delayed until user confirmation is received.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases in a claim mean that the claim is not intended to and should not be interpreted to be limited to any of the corresponding structures, materials, or acts or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

The terms and expressions used herein have the ordinary meaning accorded to such terms and expressions in their respective areas, except where specific meanings have been set forth. Relational terms such as first and second and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by “a” or “an” does not, without further constraints, preclude the existence of additional elements of the identical type.

The Abstract is provided to help the reader quickly ascertain the nature of the technical disclosure. It is submitted with the understanding that it will not be used to interpret or limit the scope or meaning of the claims. In addition, various features in the foregoing Detailed Description are grouped together in various embodiments to streamline the disclosure. This method of disclosure is not to be interpreted as requiring that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as separately claimed subject matter.

The invention claimed is:

1. A wireless mobile communication device comprising:
a wireless mobile communication module configured to wirelessly communicate with at least one social network;
an event detection module configured to detect events that take place relating to the wireless mobile communication device;
a pre-event user option module configured to allow a user of the wireless mobile communication device to specify one or more user options relating to the events, including, among multiple types of events selectable to trigger social network updates, types of events that are to trigger the social network updates; and
a social network update module configured to cause the wireless mobile communication module to update the at least one social network with information that is descriptive of each event of any of the specified types of events in response to the occurrence of the event.

2. The wireless mobile communication device of claim 1 wherein, in response to the occurrence of at least one event of any of the specified types, the social network update module is configured to cause the update to be made automatically without a user of the wireless mobile communication device having to take any action following the occurrence of the event.

3. The wireless mobile communication device of claim 1 wherein, in response to the occurrence of at least one event of any of the specified types, the social network update module is configured to:
ask a user of the wireless mobile communication device whether the user wishes to update the at least one social network with information descriptive of the event; and
cause such update to be made if and only if the user responds in the affirmative.

4. The wireless mobile communication device of claim 3 wherein, in response to the occurrence of at least one event of any of the specified types, the social network update module is configured to:
ask the user whether the user wishes to defer advising whether the user wishes to update the at least one social network with information descriptive of the event; and
ask the user the same question again at a later time if and only if the user answers in the affirmative.

5. The wireless mobile communication device of claim 3 wherein, in response to the occurrence of at least one event of any of the specified types, the social network update module is configured to:
ask the user whether the user wishes to defer updating the at least one social network with information descriptive of the event; and
cause such update to be made at a deferred time if and only if the user responds in the affirmative.

6. The wireless mobile communication device of claim 1 wherein the pre-event option module is configured to allow the user to specify the arrival of an incoming communication and/or the delivery of an outgoing communication from the wireless mobile communication device as one of the types of trigger events.

7. The wireless mobile communication device of claim 1 wherein the pre-event option module is configured to allow the user to specify an event in a calendar accessible to the wireless mobile communication device as one of the types of trigger events.

8. The wireless mobile communication device of claim 1 wherein the pre-event option module is configured to allow the user to specify the arrival of the wireless mobile communication device at a specified geographic location as one of the types of trigger events.

9. The wireless mobile communication device of claim 1 wherein the pre-event user option module is configured to allow the user to specify which of multiple social networks are to be updated by the social network update module as one of the options.

10. The wireless mobile communication device of claim 1 wherein the pre-event user option module is configured to allow the user to specify which of multiple groups of people in the at least one social network are to be updated by the social network update module as one of the options.

11. The wireless mobile communication device of claim 1 further comprising a diary module configured to store information that is descriptive of all of the events of all of the specified types in a single database.

12. A wireless mobile communication device comprising:
a wireless mobile communication module configured to wirelessly communicate with at least one social network;
an event detection module configured to detect events that take place relating to the wireless mobile communication device; and
a social network update module configured in response to the occurrence of at least one event to:
ask a user of the wireless mobile communication device whether the user wishes to update the at least one social network with information descriptive of the event; and
cause such update to be made if only if the user responds in the affirmative.

13. The wireless mobile communication device of claim 12 wherein, in response to the occurrence of the at least one event, the social network update module is configured to:
ask the user whether the user wishes to defer advising whether the user wishes to update the at least one social network with information descriptive of the event; and
ask the user again at a later time whether the user wishes to update the at least one social network with information descriptive of the event if and only if the user answers in the affirmative.

14. The wireless mobile communication device of claim 13 wherein, in response to the occurrence of the at least one event, the social network update module is configured to:
ask the user whether the user wishes to defer updating the at least one social network with information descriptive of the event; and
cause such update to be made at a deferred time if and only if the user responds in the affirmative.

15. A wireless mobile communication device comprising:
a wireless mobile communication module configured to wirelessly communicate with at least one social network;
an event detection module configured to detect communications of the wireless mobile communication device with a network device; and
a social network update module configured to cause the wireless mobile communication module to update the at least one social network with information that is descriptive of each communication in response to the detection of each communication.

16. The wireless mobile communication device of claim 15 wherein, in response to the occurrence of at least one of the communications, the social network update module is configured to cause the update to be made automatically without a user of the wireless mobile communication device having to take any action following the occurrence of the communication.

17. The wireless mobile communication device of claim 15 wherein, in response to the occurrence of at least one of the communications, the social network update module is configured to:
ask a user of the wireless mobile communication device whether the user wishes to update the at least one social network with information descriptive of the communication; and
cause such update to be made if and only if the user responds in the affirmative.

18. The wireless mobile communication device of claim 15 further comprising a pre-event user option module configured to allow a user of the wireless mobile communication device to specify which of multiple social networks are to be updated by the social network update module.

19. The wireless mobile communication device of claim 15 further comprising a pre-event user option module configured to allow a user of the wireless mobile communication device to specify which of multiple groups of people in the at least one social network are to be updated by the social network update module.

20. The wireless mobile communication device of claim 15 wherein the pre-event option module is configured to allow the user to specify the names of persons or groups of persons with whom communications are to trigger a social network update.
